(19) United States
(12) Patent Application Publication
(10) Pub. No.: US 2025/0283537 A1
(43) Pub. Date: Sep. 11, 2025

(54) VALVE SEALING STRUCTURES

(71) Applicant: FISHER JEON GAS EQUIPMENT (CHENGDU) CO., LTD., Sichuan Sheng (CN)

(72) Inventors: David Peng, Chengdu (CN); John Yang, Chengdu (CN); Yanwei Lei, Chengdu (CN); Markus Yang, Chengdu (CN); Lily Cao, Chengdu (CN)

(21) Appl. No.: 19/072,747

(22) Filed: Mar. 6, 2025

(30) Foreign Application Priority Data
Mar. 8, 2024 (CN) 202420453732.5
Aug. 23, 2024 (CN) 202411172861.8

(51) Int. Cl. F16K 1/42; F16K 1/38

(52) U.S. Cl. CPC F16K 1/42; F16K 1/38

(57) ABSTRACT

Valve sealing structures are disclosed. An example apparatus includes a valve body including a seat, and a valve plug including a disc holder including a recess; a seat ring positioned in the recess, the seat ring including a first surface and a second surface contiguous with the first surface, the first surface to contact the seat when the valve plug is in a closed position; and a disc cover coupled to the disc holder, the disc cover including a third surface and a fourth surface contiguous with the third surface, the third surface to be flush with the first surface, the fourth surface to contact the second surface and apply an axial pre-load force to the seat ring.

### RELATED APPLICATIONS

This patent claims the benefit of Chinese Patent Application No. 202420453732.5, which was filed on Mar. 8, 2024, and Chinese Patent Application No. 202411172861.8, which was filed on Aug. 23, 2024. Chinese Patent Application No. 202420453732.5 and Chinese Patent Application No. 202411172861.8 are hereby incorporated herein by reference in its entirety. Priority to Chinese Patent Application No. 202420453732.5 and Chinese Patent Application No. 202411172861.8 is hereby claimed.

### FIELD OF THE DISCLOSURE

This disclosure relates generally to valves and, more particularly, to valve sealing structures.

### BACKGROUND

In recent years, disc seals (e.g., disc-shaped sealing structures, seat rings, etc.) have been used in valves to control fluid flow through an opening. The disc seal can be part of a plug that blocks a middle portion of the opening, and the disc seal can define a perimeter of a portion of the plug and contact a seat (e.g., a plug seat) to block a perimeter of the opening. Accordingly, the disc seal prevents fluid from flowing through the opening when the valve is in the closed position.

### BRIEF DESCRIPTION OF THE DRAWINGS

FIG. 1 illustrates an example valve including a disc holder, a seat ring, and a disc cover in accordance with examples disclosed herein.

FIG. 2 illustrates the valve of FIG. 1 in a first example position.

FIG. 3 illustrates the valve of FIG. 1 in a second example position.

FIG. 4 illustrates a magnified view of a portion of the valve of FIGS. 1-3 in the second example position of FIG. 3.

FIG. 5 illustrates an isolated view of the seat ring of FIGS. 1-4.

FIG. 6 illustrates an isolated view of the disc cover of the valve of FIGS. 1-3.

FIG. 7 illustrates an isolated view of the disc holder of the valve of FIGS. 1-3.

FIG. 8 illustrates another example seat ring that can be implemented in the valve of FIG. 1 in accordance with examples disclosed herein.

FIG. 9 illustrates another example seat ring that can be implemented in the valve of FIG. 1 in accordance with examples disclosed herein.

FIG. 10 illustrates another example seat ring that can be implemented in the valve of FIG. 1 in accordance with examples disclosed herein.

FIG. 11 illustrates another example seat ring that can be implemented in the valve of FIG. 1 in accordance with examples disclosed herein.

FIG. 12 illustrates another example seat ring that can be implemented in the valve of FIG. 1 in accordance with examples disclosed herein.

In general, the same reference numbers will be used throughout the drawing(s) and accompanying written description to refer to the same or like parts. The figures are not necessarily to scale.

### DETAILED DESCRIPTION

A valve typically includes a seat ring (e.g., a seal, a disc sealing structure) to contact a seat of a valve body (e.g., a perimeter of a conduit). The seat ring prevents fluid from flowing between the seat and the seat ring when the valve is in a closed position. For example, a plug of the valve can include the seat ring, a disc holder, and a disc cover. The disc holder can include a slot (e.g., a recess) for the seat ring. Further, the disc cover can couple to the disc holder and compress the seat ring to provide an axial pre-load force to the seat ring. Pre-loading the seat ring improves the sealing capabilities associated therewith. For example, pre-loading can cause the seat ring to conform to irregularities and imperfections in contacted surfaces to ensure a tighter seal and reduce leakage. Additionally, pre-loading can help reduce seal or gasket relaxation, improve load distribution and resilience to temperature changes, and prevent movement of the seat ring to increase a pressure at which the seat ring can maintain sealing capabilities.

During operation, the valve plug can move (e.g., translate) along an axis (e.g., a longitudinal axis of the valve) to move the seat ring toward and away from the seat to control a flow of fluid past the valve. In some instances, a surface of the disc cover is positioned at an angle relative to the longitudinal axis of the valve such that the surface at least partially faces the conduit through which fluid flow is blocked when the valve is in the closed position.

In some known implementations, a surface of the seat ring that contacts the seat when the valve is in the closed position (e.g., a sealing surface) is positioned at a same angular orientation as the first surface of the disc cover. However, in some such implementations, adjacent ends of the sealing surface and the surface of the disc cover are separated by a gap such that a boundary of the flow path defined by seat ring and the disc cover is not level, which causes the fluid flowing through the valve to exhibit undesirable flow properties, such as a vortex or other inefficient and/or unpredictable flow.

In some other known implementations, the sealing surface abuts the surface of the disc cover. However, in such known implementations, another surface (e.g., a non-sealing surface) of the seat ring contiguous with the sealing surface is substantially parallel to the longitudinal axis of the valve to enable the sealing surface to abut the surface of the disc cover. As a result, a relatively small angle is defined at a tip of the seat ring between the sealing surface and the non-sealing surface. Several factors can cause the tip to rupture or protrude from the slot of the disc holder, which negatively affects sealing capabilities and/or fluid flow. For instance, the rupture or protrusion can result from a difference in area between the seat ring and a portion of the disc cover that extends through the seat ring. Additionally or alternatively, the rupture or protrusion can result from thermal expansion of valve components, such as an O-ring that contacts the seat ring.

Examples disclosed herein provide valve plugs that define smooth flow path boundaries while also maintaining sealing capabilities at relatively higher pressures. Examples disclosed herein include seat rings that have a sealing surface aligned along a same geometric plane as and abutting (e.g., flush with) an adjacent surface of the disc cover. The example seat rings disclosed herein also have a non-sealing surface that is contiguous with the sealing surface and that is nonparallel to the longitudinal axis of the valve. As such, the non-sealing surface receives a pre-load force from the disc cover proximate an end of the sealing surface, which increases a contact area across which the disc cover applies the pre-load to the seat ring. Thus, the seat ring receives the pre-load across a greater portion of a width of the seat ring (e.g., between an inner diameter and outer diameter thereof). As a result, the seat ring can provide sealing at relatively higher pressures while also providing a smooth flow path boundary at a transition between the seat ring and the disc cover to minimize undesirable flow properties.

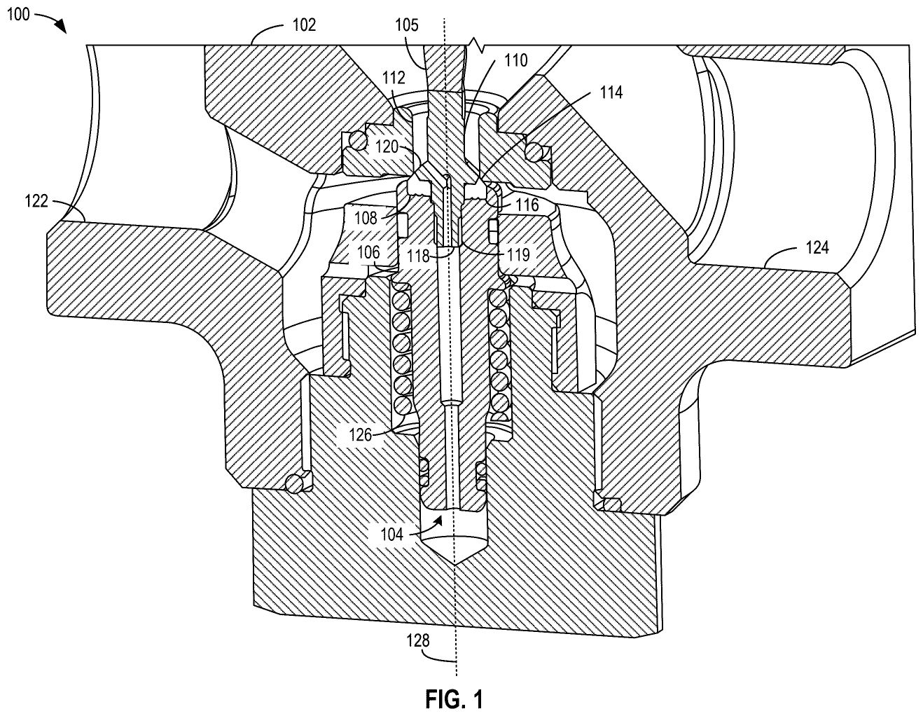

Turning to the figures, FIG. 1 illustrates an example valve 100 including a valve body 102 and a valve plug 104 (e.g., a seat sealing structure). The valve plug 104 includes a valve stem 105, a disc holder 106, a seat ring 108 (e.g., a seal or gasket), and a disc cover 110. The valve body 102 includes an inner wall 112 and a seat 114 (e.g., a plug seat) positioned around an orifice. In some examples, the seat 114 is positioned at an end of the inner wall 112.

In the illustrated example of FIG. 1, the seat ring 108 is positioned between the disc holder 106 and the disc cover 110. Specifically, the disc holder 106 includes a recess 116 (e.g., a recessed portion, a slot, etc.) in which the seat ring 108 is positioned. The seat ring 108 is disc-shaped (e.g., ring-shaped). A first portion 118 (e.g., an inner portion, a lower portion in the orientation of the valve 100 in FIG. 1) of the disc cover 110 extends through an inner diameter (e.g., an opening) of the seat ring 108 and couples to the disc holder 106. In this example, the first portion 118 includes threads 119 to couple the disc cover 110 to the disc holder 106.

In the illustrated example of FIG. 1, a second portion 120 (e.g., an outer portion, an upper portion in the orientation of the valve 100 in FIG. 1) contacts a surface (e.g., an upper surface) of the seat ring 108 and applies an axial pre-load force to the seat ring 108, as discussed in further detail below. As a result, the seat ring 108 is compressed between the disc holder 106 and the disc cover 110 to enhance sealing capabilities associated therewith. For example, a rotation of the disc cover 110 to threadedly couple the disc cover 110 to the disc holder 106 can result in linear movement of the disc cover 110 towards the disc holder 106 and the seat ring 108 to compress the seat ring 108 against the disc holder 106.

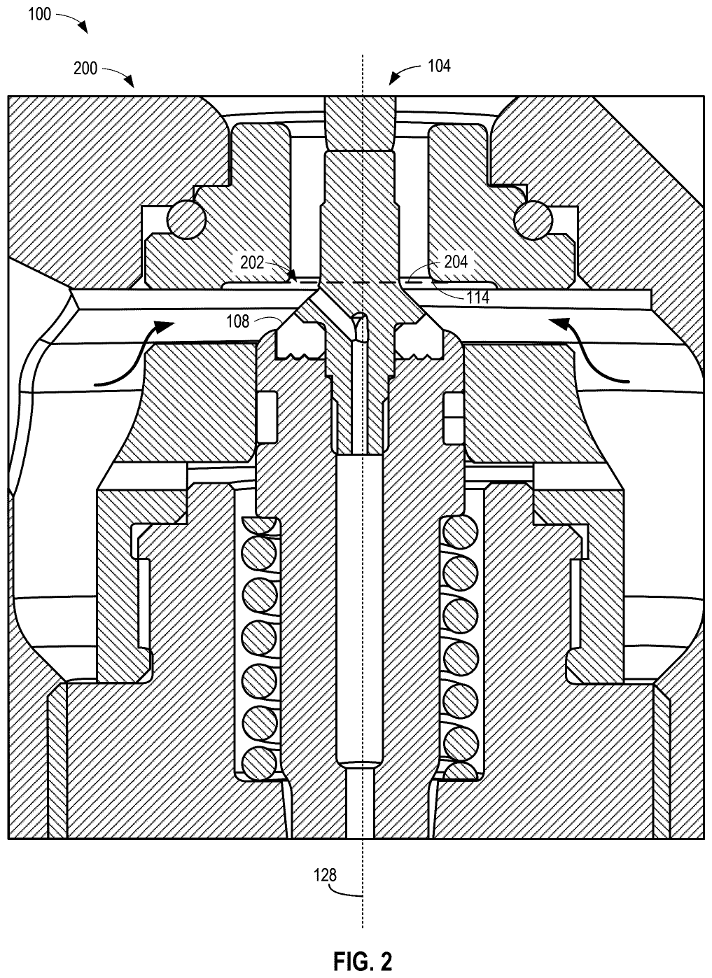

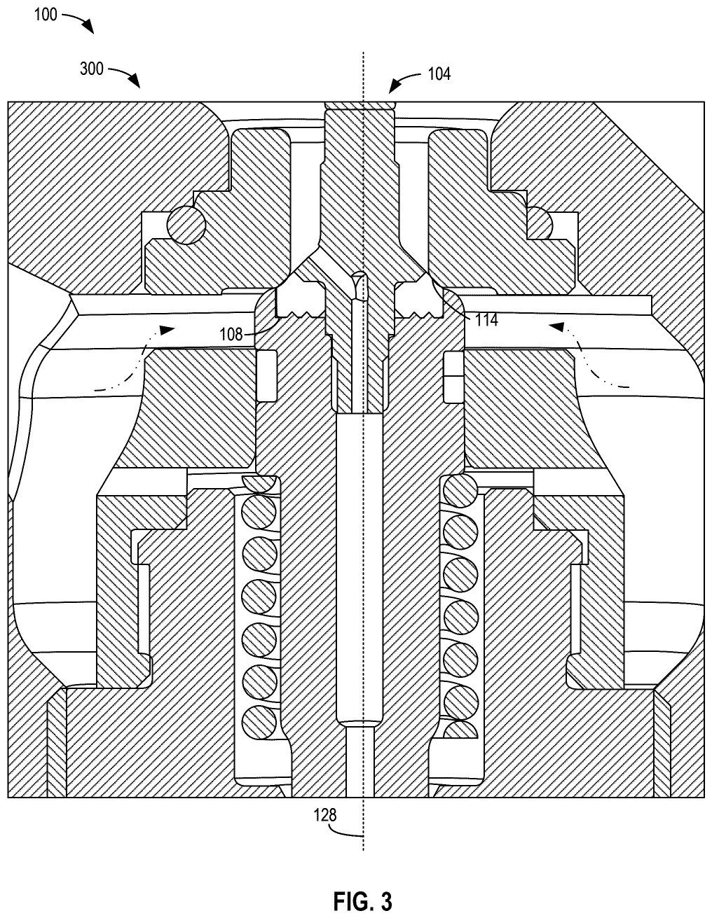

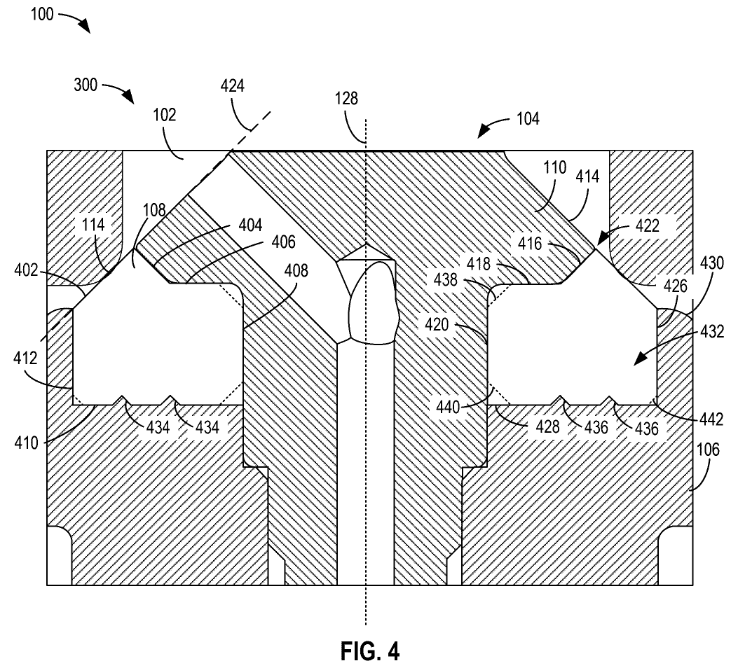

In the illustrated example of FIG. 1, the valve plug 104 is movable between (i) a first position (e.g., an open position) in which the seat ring 108 is separated from the seat 114 to enable fluid to flow therebetween and (ii) a second position (e.g., a closed position) in which the seat ring 108 contacts the seat 114 to block or prevent a fluid from flowing through the orifice in the valve body 102. Specifically, when the valve plug 104 is in the first position, the valve plug 104 opens a flow path between the seat ring 108 and the seat 114 to enable fluid to flow from the first conduit 122 to the second conduit 124, as discussed further in association with FIG. 2. When the valve plug 104 is in the second position, the valve plug 104 blocks fluid in a first conduit 122 of the valve body 102 from flowing past the seat 114 and into a second conduit 124 downstream of the first conduit 122, as discussed further in association with FIGS. 3 and 4. In some examples, the position of the valve plug 104 can be modulated to one or more intermediate positions between the first position and the second position to adjust a space provided between the seat ring 108 and the seat 114 and, in turn, adjust a flow rate of fluid flowing from the first conduit 122 to the second conduit 124.

In the illustrated example of FIG. 1, the valve 100 includes a spring 126 to facilitate movement of the valve plug 104. Specifically, the spring 126 urges the valve plug 104 along an axis 128 (e.g., a longitudinal axis of the valve plug 104) between the first position and the second position. That is, the valve plug 104 is translatably coupled to the valve body 102. In some examples, the spring 126 moves the valve plug 104 to the second position when a pressure downstream of the valve plug 104 satisfies (e.g., is greater than, is greater than or equal to) a pressure threshold. For example, when the pressure satisfies the pressure threshold, the spring 126 can be released from a biased configuration to translate the valve plug 104 and press the seat ring 108 against the seat 114 to close a flow path defined by the valve 100. In some other examples, the valve 100 includes another actuator (e.g., a servo motor) to translate the valve plug 104 along the axis 128 between the first position and the second position based on a flow rate to be obtained.

FIG. 2 illustrates the valve 100 of FIG. 1 including the valve plug 104 in an example open position 200. In FIG. 2, the seat ring 108 is separated from the seat 114 to enable fluid to flow therebetween. In FIG. 2, an orifice 202 defined by the seat 114 is aligned along a geometric plane 204 that is substantially perpendicular to the axis 128 along which the valve plug 104 translates. In this example, the orifice 202 has a diameter of approximately 10 millimeters (mm.).

FIG. 3 illustrates the valve 100 of FIG. 1 including the valve plug 104 in an example closed position 300. In the closed position 300 of FIG. 3, the seat ring 108 contacts the seat 114 to block fluid from flowing therebetween (e.g., through the orifice 202 (FIG. 2)). For example, the valve plug 104 can translate along the axis 128 to move from the open position 200 of FIG. 2 to the closed position 300 of FIG. 3 to reduce the flow rate of the fluid flowing from the first conduit 122 to the second conduit 124.

FIG. 4 illustrates a magnified view of a portion of the valve 100 of FIGS. 1-3 including the valve plug 104 in the example closed position 300 of FIG. 3. Accordingly, the seat ring 108 is in contact with the seat 114. In some examples, when the valve plug 104 is in the closed position 300, the seat ring 108 is compressed against the seat 114 to increase a contact area therebetween and maintain the seal at relatively higher pressures. In some such examples, the seat ring 108 encounters elastic deformation.

In the illustrated example of FIG. 4, the seat ring 108 includes a first surface 402 (e.g., a first face, a first bevel), a second surface 404 (e.g., a second face, a second bevel), a third surface 406 (e.g., a third face), a fourth surface 408 (e.g., a fourth face), a fifth surface 410 (e.g., a fifth surface), and a sixth surface 412. The first surface 402 contacts the seat 114 when the valve plug 104 is in the closed position 300. The second surface 404, the third surface 406, and the fourth surface 408 are in contact with the disc cover 110. The fifth surface 410 and the sixth surface 412 are in contact with the disc holder 106.

In the illustrated example of FIG. 4, the first surface 402 is contiguous with the second surface 404. Contiguous surfaces herein can be connected by a sharp edge or a curved edge (e.g., a chamfer or fillet) at respective ends of the surfaces. As used herein, a first surface is distinct, and referred to separately, from a second surface that is contiguous with the first surface when there is a change in angular orientation between the first surface and the second surface.

In the illustrated example of FIG. 4, the first surface 402 and the second surface 404 include bevels that are oblique relative to the axis 128 along which the valve plug 104 translates. As such, the first surface 402 and the second surface 404 are non-perpendicular and nonparallel to the axis 128. Similarly, the first surface 402 and the second surface 404 are oblique to the geometric plane 204 (FIG. 2) defined by the orifice (202) around which the seat 114 is positioned. In some examples, the first surface 402 is positioned (e.g., oriented) at a first angle relative to the axis 128 between 15 degrees) (° and 90°. In some examples, the second surface 404 is positioned (e.g., oriented) at a second angle relative to the axis 128 between 0° and 150°. For example, the first angle can be approximately 45° relative to the axis 128 in a first direction, and the second angle can be approximately 45° relative to the axis 128 in a second direction opposite the first direction.

In some examples, the third surface 406 is contiguous with the second surface 404; the fourth surface 408 is contiguous with the third surface 406; the fifth surface 410 is contiguous with the fourth surface 408; and/or the sixth surface 412 is contiguous with the first surface 402 and/or the fifth surface 410. In some examples, the third surface 406 and/or the fifth surface 410 are substantially parallel to the axis 128 along which the valve plug 104 translates. In some examples, at least a portion of the fourth surface 408 is substantially perpendicular to the axis 128.

In the illustrated example of FIG. 4, the disc cover 110 includes a seventh surface 414 (e.g., a seventh face, a third bevel surface), an eighth surface 416 (e.g., an eighth face, a fourth bevel surface), a ninth surface 418 (e.g., a ninth face), and a tenth surface 420. In some examples, the seventh surface 414 is contiguous with the eighth surface 416; the eighth surface 416 is contiguous with the ninth surface 418; and/or the ninth surface 418 is contiguous with the tenth surface 420. The seventh surface 414 is flush with the first surface 402. That is, the first surface 402 and the seventh surface 414 abut and are aligned along a same geometric plane 424. Accordingly, the seventh surface 414 is positioned (e.g., oriented) at the first angle relative to the axis 128 (e.g., a same angle as the first surface 402). As a result, a transition area 422 in a flow path boundary between the seat ring 108 and the disc cover 110 (e.g., between the first surface 402 and the seventh surface 414) does not generate a vortex in the fluid flow or otherwise affect flow characteristics in an undesirable manner (e.g., an unpredictable manner, a manner that reduces controllability of the flow properties) as the fluid flows across the transition area 422.

In the illustrated example of FIG. 4, the eighth surface 416 is in contact with the second surface 404, and the ninth surface 418 is in contact with the third surface 406. The eighth surface 416 is positioned at the second angle relative to the axis 128 (e.g., a same angle as the second surface 404). In some examples, the ninth surface 418 is positioned substantially perpendicular to the axis 128. In such examples, an angle of the eighth surface 416 relative to the ninth surface 418 is greater than 90°. In some examples, the tenth surface 420 is substantially parallel to the axis 128.

In the illustrated example of FIG. 4, the eighth surface 416 and the ninth surface 418 apply an axial pre-load force to the seat ring 108. That is, the eighth surface 416 and the ninth surface 418 apply a force that compresses the seat ring 108 against the disc holder 106. Specifically, the eighth surface 416 applies a first force to the second surface 404 that is normal to the second surface 404, and the ninth surface 418 applies a second force to the third surface 406 that is normal to the third surface 406. Accordingly, the first force is oblique to the axis 128, and the second force is substantially parallel to the axis 128. As such, the threads 119 (FIG. 1) of the disc cover 110 enable conversion of a rotation of the disc cover 110 to linear movement that applies the first force and the second force.

Advantageously, the angular orientation of the second surface 404 and the eighth surface 416 increases a surface area across which the disc cover 110 can apply the pre-load to the seat ring 108. Further, the surfaces 404, 416 contiguous with the first surface 402 and the seventh surface 414, respectively, can receive and apply the pre-load proximate the first surface 402 while the first surface 402 is flush with the seventh surface 414. As such, the seat ring 108 and the disc cover 110 enable an increased pre-load to be applied to the seat ring 108 for improved sealing of the orifice 202 (FIG. 2) (e.g., sealing at relatively higher pressures) while avoiding a negative effect on the fluid flow properties.

In the illustrated example of FIG. 4, the disc holder 106 includes an eleventh surface 426 (e.g., an eleventh face), a twelfth surface 428 (e.g., a twelfth face), and a thirteenth surface 430 (e.g., a thirteenth face). In some examples, the eleventh surface 426 is contiguous with the twelfth surface 428 and the thirteenth surface 430. In some examples, the eleventh surface 426 is substantially parallel to the axis 128. In some examples, at least a portion of the twelfth surface 428 is substantially perpendicular to the axis 128. The thirteenth surface 430 defines a portion of a boundary of the flow path in the valve body 102. The eleventh surface 426 and the twelfth surface 428 define a recess 432 (e.g., a slot or groove) in the disc holder 106 in which the seat ring 108 is positioned. Specifically, the eleventh surface 426 is in contact with the sixth surface 412, and the twelfth surface 428 is in contact with the fifth surface 410.

In the illustrated example of FIG. 4, the fifth surface 410 includes raised portions 434 (e.g., raised edges, recesses, indents), and the twelfth surface 428 includes protrusions 436 that extend past a portion (e.g., a planar portion) of the fifth surface 410 and into cavities defined by the raised portion 434. Specifically, the raised portions 434 can define a first serrated portion of the fifth surface 410, and the protrusions 436 can define a second serrated portion of the twelfth surface 428 that meshes with the first serrated portion. For example, the raised portions 434 and the protrusions 436 can define concentric serrations. Advantageously, the raised portions 434 and the protrusions 436 block leakage of the fluid between the fifth surface and the twelfth surface 428, which can remove a need for an O-ring between a bottom surface (e.g., the fifth surface 410) of the seat ring 108 and the disc holder 106. Moreover, an O-ring typically requires a seat ring (e.g., the seat ring 108) to have a relatively longer width (e.g., between the fourth surface 408 and the sixth surface 412) to provide enough contact area between the seat ring and the O-ring to prevent such leakage. As such, the raised portions 434 and the protrusions 436 also enable a size of the seat ring 108, and, in turn, the valve plug 104, to be reduced. Although the illustrated example of FIG. 4 depicts two of the raised portions 434 and corresponding protrusions 436 positioned therein, the fifth surface 410 and the twelfth surface 428 can include a different number of raised portions 434 and protrusions 436, respectively. For example, the fifth surface 410 and the twelfth surface 428 can include one raised portion 434 and one protrusion 436, respectively. Alternatively, the fifth surface 410 and the twelfth surface 428 can include more than two raised portions 434 and more than two protrusions 436 positioned therein.

In some examples, the seat ring 108 includes a first temporary face 438 (e.g., a first pre-installation face) between the third surface 406 and the fourth surface 408; a second temporary face 440 (e.g., a second pre-installation face) between the fourth surface 408 and the fifth surface 410; and a third temporary face 442 (e.g., a third pre-installation face) between the fifth surface 410 and the sixth surface 412. In such examples, the temporary faces 438, 440, 442 flex when the disc cover 110 compresses the seat ring 108 against the disc holder to fill gaps between (i) the seat ring 108 and the disc holder 106 and (ii) between the seat ring 108 and the disc cover 110. Accordingly, when the temporary faces 438, 440, 442 flex, the temporary faces 438, 440, 442 change to (e.g., deform, morph into) a curved edge between (i) the third surface 406 and the fourth surface 408, (ii) the fourth surface 408 and the fifth surface 410, and (iii) the fifth surface 410 and the sixth surface 412. As a result, the third surface 406 becomes contiguous with the fourth surface 408; the fourth surface 408 becomes contiguous with the fifth surface 410; and the fifth surface 410 becomes contiguous with the sixth surface 412 when the disc cover 110 compresses the seat ring 108 against the disc holder 106.

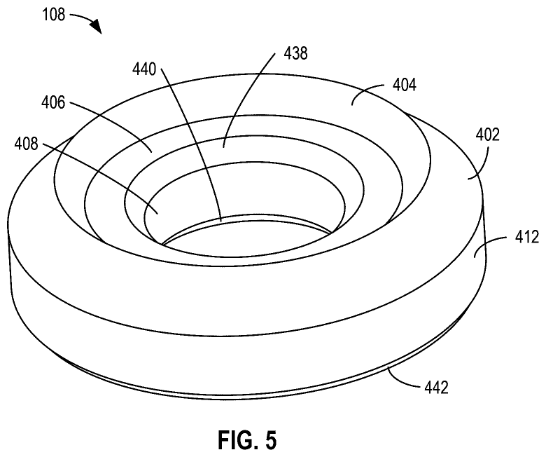

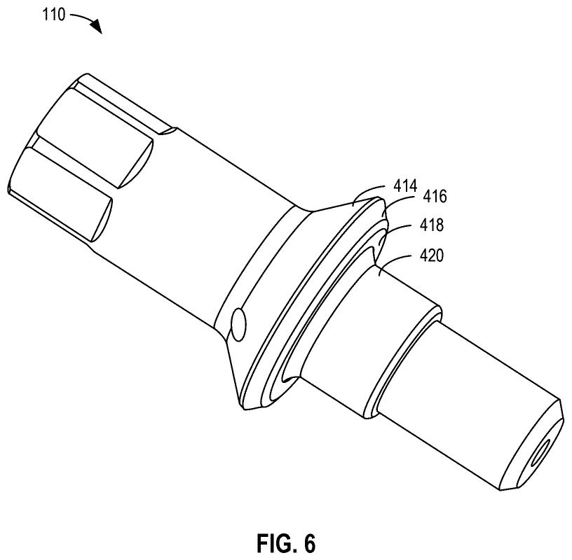

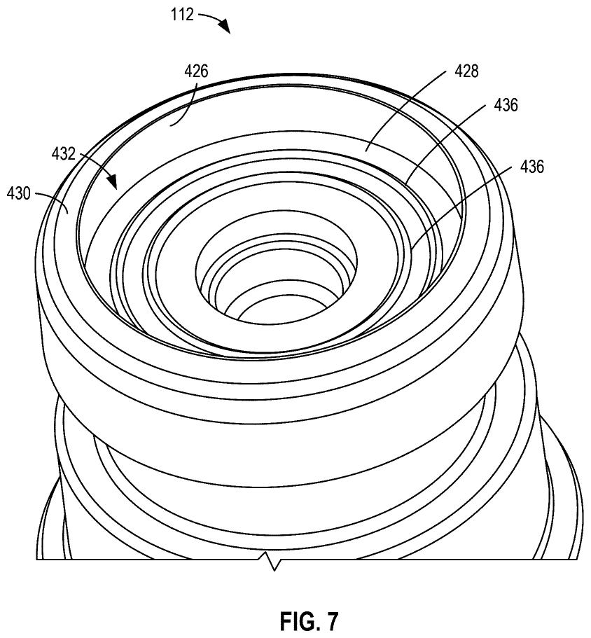

FIG. 5 illustrates an isolated view of the seat ring 108 including the first surface 402, the second surface 404, the third surface 406, the fourth surface 408, the sixth surface 412, the first temporary face 438, the second temporary face 440, and the third temporary face 442. FIG. 6 illustrates an isolated view of the disc cover 110 including the seventh surface 414, the eighth surface 416, the ninth surface 418, and the tenth surface 420. FIG. 7 illustrates an isolated view of the disc holder 106 including the eleventh surface 426, the twelfth surface 428, the thirteenth surface 430, the recess 432, and the protrusions 436.

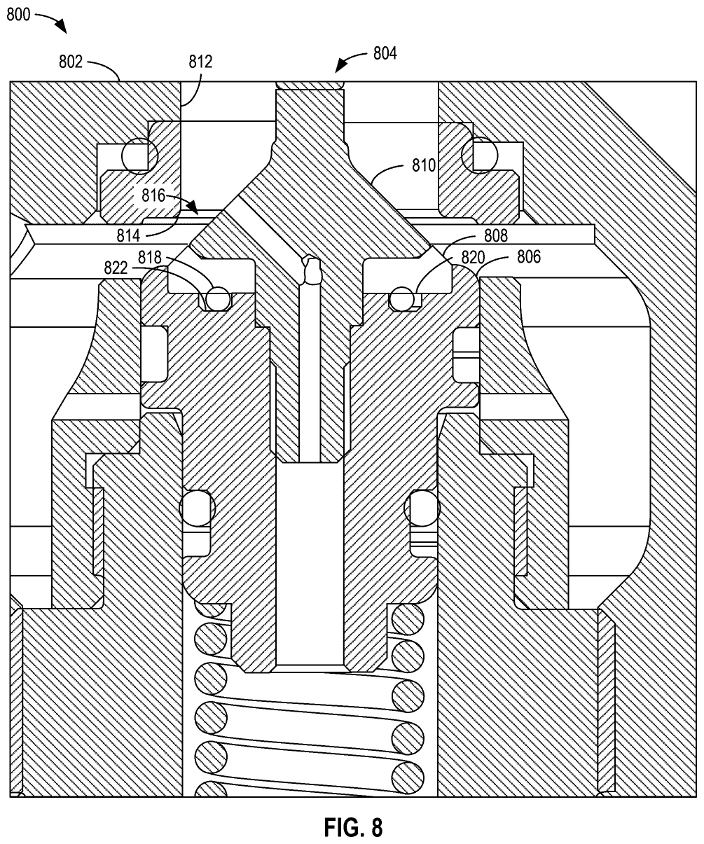

FIG. 8 illustrates another example valve 800 including another example valve body 802 and another example valve plug 804. The valve plug 804 includes a disc holder 806, a seat ring 808, and a disc cover 810. The valve body 802 includes an inner wall 812 and a seat 814 positioned around an orifice 816. The valve 800 is substantially similar to the valve 100 of FIGS. 1-4 except that the orifice 816 is larger than the orifice 202 (FIG. 2) of the valve 100 of FIGS. 1-4. As a result, the disc holder 806, the seat ring 808, and the disc cover 810 include an increased width (e.g., a larger diameter) relative to the valve plug 104 of FIGS. 1-4 (e.g., relative to the disc holder 106 (FIGS. 1-4 and 7), the seat ring 108 (FIGS. 1-5), and the disc cover 110 (FIGS. 1-4 and 6)) to block the orifice 816 when the valve plug 804 is in a closed position (e.g., the closed position 300 of FIGS. 3-4). As a result of the increased width, the valve plug 804 of FIG. 8 includes an O-ring 818 positioned between a portion of a first surface 820 (e.g., a first face, a lower surface) of the seat ring 808 and a second surface 822 (e.g., a second face, an upper surface) of the disc holder 806, in addition to or instead of the raised portions 434 (FIG. 4) and the protrusions 436 (FIGS. 4 and 7), to block fluid from flowing between the first surface 820 and the second surface 822.

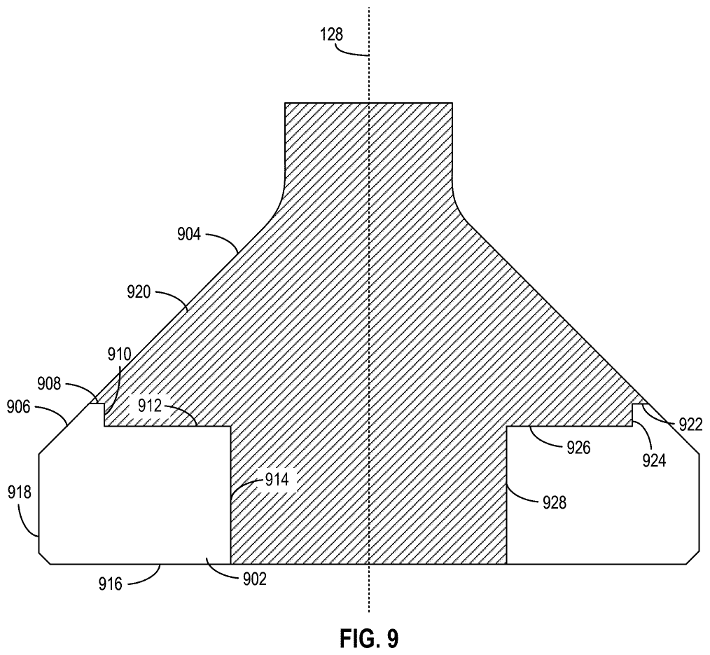

FIG. 9 illustrates an isolated view of another example seat ring 902 and disc cover 904 of a valve plug that can be implemented in the valve body 102 of FIG. 1 and/or the valve body 802 of FIG. 8 in accordance with examples disclosed herein. In the illustrated example of FIG. 9, the seat ring 902 includes a first surface 906 (e.g., a first face), a second surface 908 (e.g., a second face), a third surface 910 (e.g., a third face), a fourth surface 912 (e.g., a fourth face), a fifth surface 914 (e.g., a fifth face), a sixth surface 916 (e.g., a sixth face), and a seventh surface 918 (e.g., a seventh face). In the illustrated example of FIG. 9, the first surface 906 is contiguous with the second surface 908 and the seventh surface 918. In some examples, the second surface 908 is contiguous with the third surface 910; the third surface 910 is contiguous with the fourth surface 912; the fourth surface 912 is contiguous with the fifth surface 914; the fifth surface 914 is contiguous with the sixth surface 916; and/or the sixth surface 916 is contiguous with the seventh surface 918.

In the illustrated example of FIG. 9, the first surface 906 is oblique relative to the axis 128 along which the seat ring 902 and the disc cover 904 translate. The second surface 908, the fourth surface 912, and/or the sixth surface 916 are substantially perpendicular to the axis 128. The third surface 910, the fifth surface 914, and/or the seventh surface 918 are substantially parallel to the axis 128.

In the illustrated example of FIG. 9, the first surface 906 contacts a seat (not shown) of a valve body (e.g., the seat 114 of FIGS. 1-4, the seat 814 of FIG. 8) when the valve plug associated with the seat ring 902 is in a closed position (e.g., the closed position 300 of FIGS. 3-4). Accordingly, fluid contacts and flows across the first surface 906 when the valve plug is in the open position (e.g., the open position 200 of FIG. 2). The sixth surface 916 and the seventh surface 918 contact a disc holder of the valve plug (e.g., the disc holder 106 of FIGS. 1-4 and 7). In some examples, the valve plug includes an O-ring positioned between a portion of the sixth surface 916 and the disc holder. In some examples, the sixth surface 916 and the disc holder include serrations (e.g., the raised portions 434 (FIG. 4) and the protrusions 436 (FIGS. 4 and 7)), as discussed above. The second surface 908, the third surface 910, the fourth surface 912, and the fifth surface 914 are in contact with the disc cover 904, as discussed in further detail below.

In the illustrated example of FIG. 9, the disc cover 904 includes an eighth surface 920 (e.g., an eighth face), a ninth surface 922 (e.g., a ninth face), a tenth surface 924 (e.g., a tenth face), an eleventh surface 926 (e.g., an eleventh face), and a twelfth surface 928 (e.g., a twelfth face). In FIG. 9, the ninth surface 922 is contiguous with the eighth surface 920 and the tenth surface 924, and the eleventh surface 926 is contiguous with the tenth surface 924 and the twelfth surface 928.

In the illustrated example of FIG. 9, the eighth surface 920 is oblique relative to the axis 128. Specifically, the eighth surface 920 is flush with (e.g., abuts and is positioned along a same geometric plane (e.g., the geometric plane 424 (FIG. 4) as) the first surface 906. The ninth surface 922 and the eleventh surface 926 are substantially perpendicular to the axis 128. The tenth surface 924 and the twelfth surface 928 are substantially parallel to the axis 128.

In the illustrated example of FIG. 9, the ninth surface 922 is in contact with the second surface 908; the tenth surface 924 is in contact with the third surface 910; the eleventh surface 926 is in contact with the fourth surface 912; and the twelfth surface 928 is in contact with the fifth surface 914. The ninth surface 922 applies a first pre-load compression force to the second surface 908, and the eleventh surface 926 applies a second pre-load compression force to the fourth surface 912. Thus, the disc cover 904 applies the first pre-load compression force to a surface (e.g., the second surface 908) that is contiguous with a surface (e.g., the first surface 906) that contacts the seat (e.g., the seat 114 (FIGS. 1-4), the seat 814 (FIG. 8)) to increase a contact area across which the pre-load is applied. As a result, the seat ring 902 receives the pre-load across an increased distance between an inner and outer diameter thereof, which increases the pre-load force received and increases a pressure that the seat ring 902 can withstand during operation. As the second surface 908 is raised relative to the fourth surface 912, the first and second pre-load compression forces are applied to the seat ring 902 at different heights (e.g., distances from the sixth surface 916). The first and second pre-load compression forces are substantially parallel to the axis 128 along which the seat ring 902 and the disc cover 904 translate during operation.

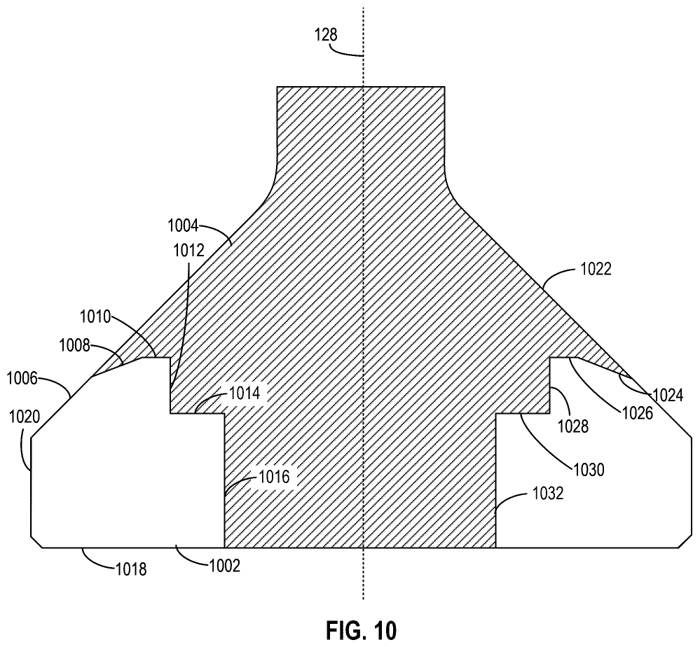

FIG. 10 illustrates an isolated view of another example seat ring 1002 and disc cover 1004 of a valve plug that can be implemented in the valve body 102 of FIG. 1 and/or the valve body 802 of FIG. 8 in accordance with examples disclosed herein. In the illustrated example of FIG. 10, the seat ring 1002 includes a first surface 1006 (e.g., a first face, a first bevel surface), a second surface 1008 (e.g., a second face, a second bevel surface), a third surface 1010 (e.g., a third face), a fourth surface 1012 (e.g., a fourth face), a fifth surface 1014 (e.g., a fifth face), a sixth surface 1016 (e.g., a sixth face), a seventh surface 1018 (e.g., a seventh face), and an eighth surface 1020 (e.g., an eighth face). In the illustrated example of FIG. 10, the first surface 1006 is contiguous with the second surface 1008 and the eighth surface 1020, and the second surface 1008 is contiguous with the third surface 1010. In some examples, the third surface 1010 is contiguous with the fourth surface 1012; the fourth surface 1012 is contiguous with the fifth surface 1014; the fifth surface 1014 is contiguous with the sixth surface 1016; the sixth surface 1016 is contiguous with the seventh surface 1018; and/or the seventh surface 1018 is contiguous with the eighth surface 1020.

In the illustrated example of FIG. 10, the first surface 1006 and the second surface 1008 are oblique relative to the axis 128 along which the seat ring 1002 and the disc cover 1004 translate during operation. The third surface 1010, the fifth surface 1014, and the seventh surface 1018 are substantially perpendicular to the axis 128. The fourth surface 1012, the sixth surface 1016, and the eighth surface 1020 are substantially parallel to the axis 128.

In the illustrated example of FIG. 10, the first surface 1006 contacts a seat (not shown) of a valve body (e.g., the seat 114 of FIGS. 1-4, the seat 814 of FIG. 8) when the valve plug associated with the seat ring 1002 is in a closed position (e.g., the closed position 300 of FIGS. 3-4). Accordingly, fluid contacts and flows across the first surface 1006 when the valve plug is in an open position (e.g., the open position 200 of FIG. 2). The seventh surface 1018 and the eighth surface 1020 contact a disc holder of the valve plug (e.g., the disc holder 106 of FIGS. 1-4 and 7). In some examples, the valve plug includes an O-ring positioned between a portion of the seventh surface 1018 and the disc holder. In some examples, the seventh surface 1018 and the disc holder include serrations (e.g., the raised portions 434 (FIG. 4) and the protrusions 436 (FIGS. 4 and 7)), as discussed above. The second surface 1008, the third surface 1010, the fourth surface 1012, the fifth surface 1014, and the sixth surface 1016 are in contact with the disc cover 1004, as discussed in further detail below.

In the illustrated example of FIG. 10, the disc cover 1004 includes a ninth surface 1022 (e.g., a ninth face), a tenth surface 1024 (e.g., a tenth face), an eleventh surface 1026 (e.g., an eleventh face), a twelfth surface 1028 (e.g., a twelfth face), a thirteenth surface 1030 (e.g., a thirteenth face), and a fourteenth surface 1032 (e.g., a fourteenth face). The tenth surface 1024 is contiguous with the ninth surface 1022 and the eleventh surface 1026. The eleventh surface 1026 is contiguous with the twelfth surface 1028. The thirteenth surface 1030 is contiguous with the twelfth surface 1028 and the fourteenth surface 1032. In the illustrated example of FIG. 10, the ninth surface 1022 and the tenth surface 1024 are oblique relative to the axis 128. The ninth surface 1022 is flush with (e.g., abuts and is positioned along a same geometric plane (e.g., the geometric plane 424 (FIG. 4) as) the first surface 1006. The eleventh surface 1026 and the thirteenth surface 1030 are substantially perpendicular to the axis 128. The twelfth surface 1028 and the fourteenth surface 1032 are substantially parallel to the axis 128.

In the illustrated example of FIG. 10, tenth surface 1024 is in contact with the second surface 1008; the eleventh surface 1026 is in contact with the third surface 1010; the twelfth surface 1028 is in contact with the fourth surface 1012; the thirteenth surface 1030 is in contact with the fifth surface 1014; and the fourteenth surface 1032 is in contact with the sixth surface 1016. The tenth surface 1024 applies a first pre-load compression force to the second surface 1008 in a direction normal to the second surface 1008 (e.g., in a direction oblique relative to the axis 128). Thus, the disc cover 1004 applies the first pre-load compression force to a surface (e.g., the second surface 1008) that is contiguous with a surface (e.g., the first surface 1006) that contacts the seat (e.g., the seat 114 (FIGS. 1-4), the seat 814 (FIG. 8)) to increase a contact area across which the pre-load is applied. Further, the eleventh surface 1026 applies a second pre-load compression force to the third surface 1010 in a direction substantially parallel to the axis 128, and the thirteenth surface 1030 applies a third pre-load compression force to the fifth surface 1014 in the direction substantially parallel to the axis 128. As a result, the seat ring 1002 receives the pre-load across an increased distance between an inner and outer diameter thereof, which increases the pre-load force received and increases a pressure that the seat ring 1002 can withstand during operation.

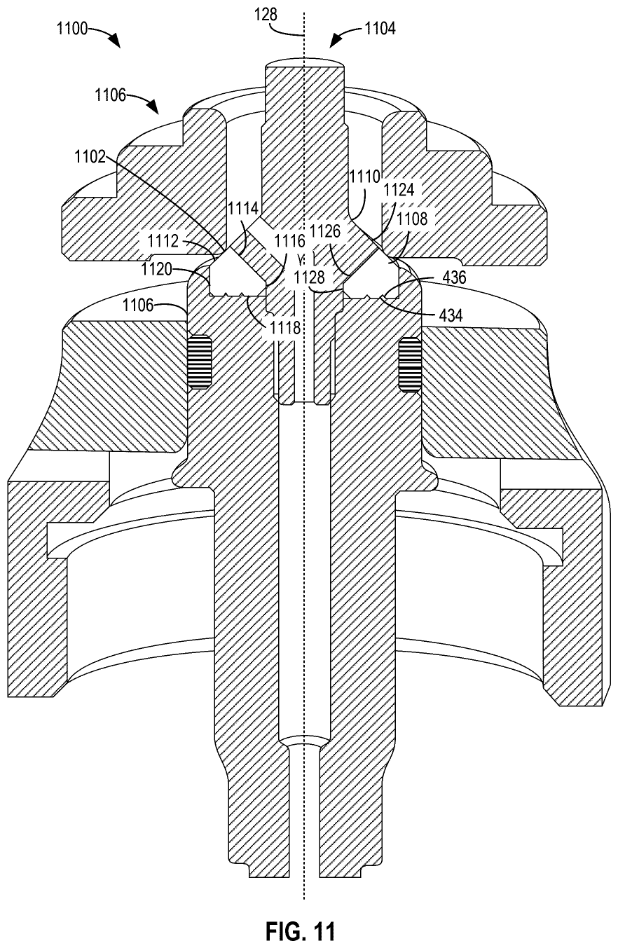

FIG. 11 illustrates a portion of another example valve 1100 including a seat 1102 (e.g., the seat 114 (FIGS. 1-4), the seat 814 (FIG. 8)) and a valve plug 1104 in a closed position 1106. The valve plug 1104 includes another example seat ring 1108, and another example disc cover 1110. The seat ring 1108 includes a first surface 1112 (e.g., a first face, a first bevel surface, the first surface 402 of FIG. 4), a second surface 1114 (e.g., a second face, a second bevel surface), a third surface 1116 (e.g., a third face), a fourth surface 1118 (e.g., a fourth face, the fifth surface 410 of FIG. 4), and a fifth surface 1120 (e.g., a fifth face, the sixth surface 412 of FIG. 4). In the illustrated example of FIG. 11, the first surface 1112 is contiguous with the second surface 1114 and the fifth surface 1120. In some examples, the third surface 1116 is contiguous with the second surface 1114 and the fourth surface 1118. Accordingly, the second surface 1114 spans from an end of the first surface 1112 to an inner diameter of the seat ring 1108. In some examples, the fourth surface 1118 is contiguous with the fifth surface 1120. In some examples, the second surface 1114 is contiguous with the fourth surface 1118 at an inner diameter thereof (e.g., the seat ring 1108 does not include the third surface 1116).

In the illustrated example of FIG. 11, the first surface 1112 and the second surface 1114 are oblique relative to the axis 128 along which the valve plug 1104 translates during operation. In some examples, the third surface 1116 and the fifth surface 1120 are substantially parallel to the axis 128. In some examples, at least a portion of the fourth surface 1118 is substantially perpendicular to the axis 128.

In the illustrated example of FIG. 11, the first surface 1112 contacts the seat 1102 when the valve plug 1104 is in the closed position 1106. Accordingly, fluid contacts and flows across the first surface 1112 when the valve plug 1104 is in an open position (e.g., the open position 200 of FIG. 2). The fourth surface 1118 and the fifth surface 1120 are in contact with the disc holder 1106. In this example, the fourth surface 1118 includes the raised portions 434, and the disc holder 1106 includes the protrusions 436, as discussed above. In some other examples, the valve plug 1104 includes an O-ring positioned between at least a portion of the fourth surface 1118 and the disc holder 1106. The second surface 1114 and the third surface 1116 are in contact with the disc cover 1110, as discussed in further detail below.

In the illustrated example of FIG. 11, the disc cover 1110 includes a seventh surface 1124 (e.g., a seventh face, the seventh surface 414 of FIG. 4), an eighth surface 1126 (e.g., an eighth face), and a ninth surface 1128 (e.g., a ninth face). The eighth surface 1126 is contiguous with the seventh surface 1124 and the ninth surface 1128. In the illustrated example of FIG. 11, the seventh surface 1124 and the eighth surface 1126 are oblique relative to the axis 128. The seventh surface 1124 is flush with (e.g., abuts and is positioned along a same geometric plane (e.g., the geometric plane 424 (FIG. 4) as) the first surface 1112. The ninth surface 1128 is substantially parallel to the axis 128.

In the illustrated example of FIG. 11, the eighth surface 1126 is in contact with the second surface 1114, and the ninth surface 1128 is contact with the third surface 1116. The eighth surface 1126 applies a pre-load compression force to the second surface 1114 in a direction normal to the second surface 1114 (e.g., in a direction oblique relative to the axis 128). Thus, the disc cover 1110 applies the pre-load compression force to a surface (e.g., the second surface 1114) that is contiguous with a surface (e.g., the first surface 1112) that contacts the seat 1102 to increase a contact area across which the pre-load is applied. As a result, the seat ring 1108 receives the pre-load across an increased distance between an inner and outer diameter thereof, which increases the pre-load force received and increases a pressure that the seat ring 1108 can withstand during operation. Moreover, as the second surface 1114 spans from the end of the first surface 1112 to the inner diameter of the seat ring 1104 such that the pre-load is applied in a same direction from the end of the first surface 1112 and the inner diameter of the seat ring 1104 to increase a uniformity with which the seat ring 1108 is pre-loaded.

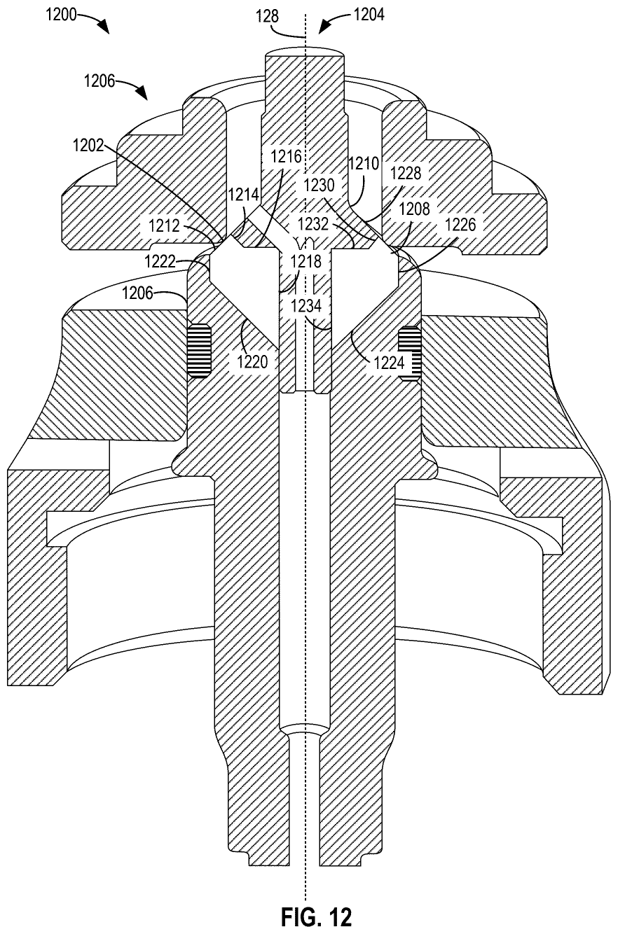

FIG. 12 illustrates a portion of another example valve 1200 including a seat 1202 (e.g., the seat 114 (FIGS. 1-4), the seat 814 (FIG. 8)) and a valve plug 1204 in a closed position 1206. The valve plug 1204 includes another example seat ring 1208, and another example disc cover 1210. The seat ring 1208 includes a first surface 1212 (e.g., a first face, a first bevel surface, the first surface 402 of FIG. 4), a second surface 1214 (e.g., a second face, a second bevel surface, the second surface 404 of FIG. 4), a third surface 1216 (e.g., a third face, the third surface 406 of FIG. 4), a fourth surface 1218 (e.g., a fourth face), a fifth surface 1220 (e.g., a fifth face, a third bevel surface), and a sixth surface 1222 (e.g., a sixth face). In the illustrated example of FIG. 12, the first surface 1212 is contiguous with the second surface 1214 and the sixth surface 1222, and the second surface 1214 is contiguous with the third surface 1216. In some examples, the fourth surface 1218 is contiguous with the third surface 1216 and/or the fifth surface 1220. In some examples, the fifth surface 1220 is contiguous with the sixth surface 1222.

In the illustrated example of FIG. 12, the first surface 1212, the second surface 1214, and the fifth surface 1220 are oblique relative to the axis 128 along which the valve plug 1204 translates. In some examples, the third surface 1216 is substantially perpendicular to the axis 128. In some examples, the fourth surface 1218 and the sixth surface 1222 are substantially parallel to the axis 128. In this example, the fifth surface 1220 is oriented at an angle greater than 90° relative to the sixth surface 1222.

In the illustrated example of FIG. 12, the first surface 1212 contacts the seat 1202 when the valve plug 1204 is in the closed position 1206. Accordingly, fluid contacts and flows across the first surface 1212 when the valve plug 1204 is in an open position (e.g., the open position 200 of FIG. 2). The second surface 1214, the third surface 1216, and the fourth surface 1218 are in contact with the disc cover 1210. The fifth surface 1220 and the sixth surface 1222 are in contact with the disc holder 1206.

In the illustrated example of FIG. 12, the disc holder 1206 includes a seventh surface 1224 (e.g., a seventh face, a fourth bevel surface) and an eighth surface 1226 (e.g., an eighth face) contiguous with the seventh surface 1224. The eighth surface 1226 is substantially parallel to the axis 128 and contacts the sixth surface 1222. The seventh surface 1224 is oblique relative to the axis 128 and contacts the fifth surface 1220. Specifically, the seventh surface 1224 is oriented at an angle greater than 90° relative to the eighth surface 1226. As a result of the angular orientation of the fifth surface 1220 and the seventh surface 1224, a size (e.g., a volume) of the seat ring 1208 is increased, which can enable the seat ring 1208 to withstand higher pressures. Additionally, the angular orientation of the fifth surface 1220 and the seventh surface 1224 increases a contact area therebetween. The increased contact area can improve sealing between the fifth surface 1220 and the seventh surface 1224 and/or improve a distribution of pressure in the seat ring 1208 that results from pre-loading to further prevent the seat ring 1208 from rupturing. In some examples, the fifth surface 1220 includes raised portions (e.g., the raised portions 434 (FIG. 4)), and the seventh surface 1224 includes the protrusions (e.g., the protrusions 436 (FIG. 4)) that mesh with the raised portions. In such examples, the raised portions and the protrusions extend along a direction normal to the seventh surface 1224 and the fifth surface 1220. In some examples, the valve plug 1204 includes an O-ring (e.g., the O-ring 818 (FIG. 8)) positioned between the fifth surface 1220 and the seventh surface 1224.

In the illustrated example of FIG. 12, the disc cover 1210 includes a ninth surface 1228 (e.g., a ninth face, a fifth bevel surface, the seventh surface 414 of FIG. 4), a tenth surface 1230 (e.g., a tenth face, a sixth bevel surface, the eighth surface 416 of FIG. 4), an eleventh surface 1232 (e.g., an eleventh face, the ninth surface 418 of FIG. 4), and a twelfth surface 1234 (e.g., a twelfth face). The tenth surface 1230 is contiguous with the ninth surface 1228 and the eleventh surface 1232, and the eleventh surface 1232 is contiguous with the twelfth surface 1234. The ninth surface 1228 and the tenth surface 1230 are oblique relative to the axis 128. The eleventh surface 1232 is substantially perpendicular to the axis 128. The twelfth surface 1234 is substantially parallel to the axis 128.

In the illustrated example of FIG. 12, the ninth surface 1228 is flush with (e.g., abuts and is positioned along a same geometric plane (e.g., the geometric plane 424 (FIG. 4) as) the first surface 1212. The tenth surface 1230 is in contact with the second surface 1214; the eleventh surface 1232 is in contact with the third surface 1216; and the twelfth surface is in contact with the fourth surface 1218. The tenth surface 1230 applies a first pre-load force to the second surface 1214, and the eleventh surface 1232 applies a second pre-load force to the third surface 1216 to improve seal that the seat ring 1208 provides in the closed position 1206 and maintain a structural integrity thereof against high pressures, as discussed in further detail above.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein in the context of describing the position and/or orientation of a first object (e.g., a first surface, a first plane, a first axis, etc.) relative to a second object (e.g., a second surface, a second plane, a second axis, etc.) the term “substantially perpendicular” encompasses the term perpendicular and more broadly encompasses a meaning whereby the first object is positioned and/or oriented relative to the second object at an absolute angle of no more than five degrees) (5° from perpendicular. For example, a first axis that is substantially perpendicular to a second axis is positioned and/or oriented relative to the second axis at an absolute angle of no more than five degrees) (5° from perpendicular.

As used herein in the context of describing the position and/or orientation of a first object (e.g., a first surface, a first plane, a first axis, etc.) relative to a second object (e.g., a second surface, a second plane, a second axis, etc.) the term “substantially parallel” encompasses the term parallel and more broadly encompasses a meaning whereby the first object is positioned and/or oriented relative to the second object at an absolute angle of no more than five degrees) (5° from parallel. For example, a first axis that is substantially parallel to a second axis is positioned and/or oriented relative to the second axis at an absolute angle of no more than five degrees) (5° from parallel.

From the foregoing, it will be appreciated that example systems, apparatus, articles of manufacture, and methods have been disclosed that increase a pressure at which a valve plug maintains a sealing capability while maintaining a flush flow path boundary to avoid undesirable flow characteristics in a valve.

Example valve sealing structures are disclosed herein. Further examples and combinations thereof include the following:
Example 1 includes an apparatus comprising a valve body including a seat, and a valve plug including a disc holder including a recess, a seat ring positioned in the recess, the seat ring including a first surface and a second surface contiguous with the first surface, the first surface to contact the seat when the valve plug is in a closed position, and a disc cover coupled to the disc holder, the disc cover including a third surface and a fourth surface contiguous with the third surface, the third surface to be flush with the first surface, the fourth surface to contact the second surface and apply an axial pre-load force to the seat ring.
Example 2 includes the apparatus of example 1, wherein the axial pre-load force is a first axial pre-load force in a first direction, wherein the seat ring includes a fifth surface, and wherein the disc cover includes a sixth surface, wherein the sixth surface contacts the fifth surface to apply a second axial pre-load force to the seat ring in a second direction different than the first direction.
Example 3 includes the apparatus of example 2, wherein the fifth surface is contiguous with the second surface, and wherein the sixth surface is contiguous with the fourth surface.
Example 4 includes the apparatus of example 1, wherein the seat ring includes a fifth surface in contact with the disc holder, and wherein the fifth surface includes raised portions.
Example 5 includes the apparatus of example 4, wherein the raised portions are first serrations, and wherein the disc holder includes second serrations that mesh with the first serrations.
Example 6 includes the apparatus of example 4, wherein the raised portions are concentric serrations.
Example 7 includes the apparatus of example 1, wherein the second surface includes a bevel that is nonparallel to a longitudinal axis of the valve plug.
Example 8 includes the apparatus of example 1, wherein the second surface includes a bevel that is oblique to a longitudinal axis of the valve plug.
Example 9 includes an apparatus comprising a valve body including an inner wall that defines a seat, the seat positioned around an orifice, a disc holder, a disc cover coupled to the disc holder, the disc cover including a first surface and a second surface that is contiguous with the first surface, the first surface at least partially facing the inner wall, and a seat ring positioned between the disc cover and the disc holder, the seat ring including a third surface and a fourth surface contiguous with the third surface, the third surface to contact the second surface, the third surface including an angular orientation that is non-perpendicular to a plane defined by the orifice, the fourth surface flush with the first surface.
Example 10 includes the apparatus of example 9, wherein the seat ring, the disc holder, and the disc cover are movable between a first position and a second position, the fourth surface to contact the seat in the first position to block fluid from flowing between the seat and the seat ring, the fourth surface separated from the seat in the second position.
Example 11 includes the apparatus of example 9, wherein at least a portion of the second surface faces the disc holder.
Example 12 includes the apparatus of example 9, wherein the angular orientation of the third surface is nonparallel to the plane defined by the orifice.
Example 13 includes the apparatus of example 9, wherein the seat ring includes a fifth surface, wherein the disc cover includes a sixth surface that contacts the fifth surface, wherein the disc cover compresses the seat ring with a first force on the fifth surface and a second force on the third surface.
Example 14 includes the apparatus of example 13, wherein the fifth surface and the sixth surface are substantially parallel to the plane defined by the orifice.
Example 15 includes the apparatus of example 14, wherein the fifth surface is contiguous with the third surface, and wherein the sixth surface is contiguous with the second surface.
Example 16 includes the apparatus of example 13, wherein the first force is approximately normal to the third surface and the second force is approximately normal to the fifth surface.
Example 17 includes the apparatus of example 13, wherein the disc cover includes threads to couple the disc cover to the disc holder, and wherein the threads enable conversion of a rotation of the disc cover to linear movement that applies the first force and the second force.
Example 18 includes the apparatus of example 9, wherein the seat ring includes a fifth surface in contact with the disc holder, and wherein the fifth surface includes an indent.
Example 19 includes the apparatus of example 18, wherein the disc holder includes a protrusion that extends into a cavity defined by the indent.
Example 20 includes an apparatus comprising a seat ring including a first face, a second face, and a third face, the first face and the third face contiguous with the second face, the first face to contact a disc holder, the third face to contact a disc cover, the second face flush with a surface of the disc cover, the seat ring movable along an axis between a first position and a second position, the second face to contact a perimeter of an orifice when the seat ring is in the first position, the second face including a first bevel that is nonparallel to the axis, the third face including a second bevel that is nonparallel to the axis.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
a valve body including a seat; and
a valve plug including:
a disc holder including a recess;
a seat ring positioned in the recess, the seat ring including a first surface and a second surface contiguous with the first surface, the first surface to contact the seat when the valve plug is in a closed position; and
a disc cover coupled to the disc holder, the disc cover including a third surface and a fourth surface contiguous with the third surface, the third surface to be flush with the first surface, the fourth surface to contact the second surface and apply an axial pre-load force to the seat ring.

2. The apparatus of claim 1, wherein the axial pre-load force is a first axial pre-load force in a first direction, wherein the seat ring includes a fifth surface, and wherein the disc cover includes a sixth surface, wherein the sixth surface contacts the fifth surface to apply a second axial pre-load force to the seat ring in a second direction different than the first direction.

3. The apparatus of claim 2, wherein the fifth surface is contiguous with the second surface, and wherein the sixth surface is contiguous with the fourth surface.

4. The apparatus of claim 1, wherein the seat ring includes a fifth surface in contact with the disc holder, and wherein the fifth surface includes raised portions.

5. The apparatus of claim 4, wherein the raised portions are first serrations, and wherein the disc holder includes second serrations that mesh with the first serrations.

6. The apparatus of claim 4, wherein the raised portions are concentric serrations.

7. The apparatus of claim 1, wherein the second surface includes a bevel that is nonparallel to a longitudinal axis of the valve plug.

8. The apparatus of claim 1, wherein the second surface includes a bevel that is oblique to a longitudinal axis of the valve plug.

9. An apparatus comprising:
a valve body including an inner wall that defines a seat, the seat positioned around an orifice;
a disc holder;
a disc cover coupled to the disc holder, the disc cover including a first surface and a second surface that is contiguous with the first surface, the first surface at least partially facing the inner wall; and
a seat ring positioned between the disc cover and the disc holder, the seat ring including a third surface and a fourth surface contiguous with the third surface, the third surface to contact the second surface, the third surface including an angular orientation that is non-perpendicular to a plane defined by the orifice, the fourth surface flush with the first surface.

10. The apparatus of claim 9, wherein the seat ring, the disc holder, and the disc cover are movable between a first position and a second position, the fourth surface to contact the seat in the first position to block fluid from flowing between the seat and the seat ring, the fourth surface separated from the seat in the second position.

11. The apparatus of claim 9, wherein at least a portion of the second surface faces the disc holder.

12. The apparatus of claim 9, wherein the angular orientation of the third surface is nonparallel to the plane defined by the orifice.

13. The apparatus of claim 9, wherein the seat ring includes a fifth surface, wherein the disc cover includes a sixth surface that contacts the fifth surface, wherein the disc cover compresses the seat ring with a first force on the fifth surface and a second force on the third surface.

14. The apparatus of claim 13, wherein the fifth surface and the sixth surface are substantially parallel to the plane defined by the orifice.

15. The apparatus of claim 14, wherein the fifth surface is contiguous with the third surface, and wherein the sixth surface is contiguous with the second surface.

16. The apparatus of claim 13, wherein the first force is approximately normal to the third surface and the second force is approximately normal to the fifth surface.

17. The apparatus of claim 13, wherein the disc cover includes threads to couple the disc cover to the disc holder, and wherein the threads enable conversion of a rotation of the disc cover to linear movement that applies the first force and the second force.

18. The apparatus of claim 9, wherein the seat ring includes a fifth surface in contact with the disc holder, and wherein the fifth surface includes an indent.

19. The apparatus of claim 18, wherein the disc holder includes a protrusion that extends into a cavity defined by the indent.

20. An apparatus comprising:
a seat ring including a first face, a second face, and a third face, the first face and the third face contiguous with the second face, the first face to contact a disc holder, the third face to contact a disc cover, the second face flush with a surface of the disc cover, the seat ring movable along an axis between a first position and a second position, the second face to contact a perimeter of an orifice when the seat ring is in the first position, the second face including a first bevel that is nonparallel to the axis, the third face including a second bevel that is nonparallel to the axis.
